(19) United States
(12) Patent Application Publication
(10) Pub. No.: US 2017/0341499 A1
(43) Pub. Date: Nov. 30, 2017

(54) Device to clamp a container onto and to release this container from a vehicle so that said container can supply energy to the said vehicle

(71) Applicants: Guillaume Marchisseau, Burbank, CA (US); Michel MARCHISSEAU, Martigues (FR)

(72) Inventors: Guillaume Marchisseau, Burbank, CA (US); Michel MARCHISSEAU, Martigues (FR)

(21) Appl. No.: 15/168,047

(22) Filed: May 29, 2016

(51) Int. Cl. B60K 1/04; H01M 8/02; H01M 2/10; F16B 2/06; B60L 11/18

(52) U.S. Cl. CPC B60K 1/04; F16B 2/065; B60L 11/1879; B60L 11/1898; H01M 2/1077; H01M 2/1083; H01M 8/02; B60K 2001/0438; B60Y 2200/91; B60Y 2200/92; B60Y 2306/01; H01M 2220/20; H01M 2250/20

(57) ABSTRACT

The invention relates to a device which equips a vehicle that includes a removable container, the device comprising at least one mechanism allowing to clamp the container onto the said vehicle and allowing also to release the container from the said vehicle, by driving a screw or a bolt, screwing to clamp on and unscrewing to unclamp.

### TECHNICAL FIELD OF THE INVENTION

The invention concerns a device allowing the clamping of a container onto a vehicle so that the container can supply some energy to this vehicle. It also regards a vehicle comprising such a device as well as a process to remove and to set up a container to such a vehicle.

### BACKGROUND OF THE INVENTION

Some vehicles, such as electric or hybrid vehicles, contain a container of batteries which can supply electric energy for driving this vehicle.

The documents U.S. Pat. No. 4,365,681 and U.S. Pat. No. 5,886,501 disclose such a container of electric batteries. These containers are bulky and heavy in order to allow the storage of enough electrical energy to provide an autonomy of more than a hundred of kilometers in full electric mode. Their general parallelepiped shape of a low height compared to the other dimensions, allows their hanging under the vehicle, the said container covering approximately the whole underside of the passenger compartment. However, the weight of the equipped vehicle is not minimized.

The document FR1011256 discloses a vehicle equipped with containers of electric batteries under the passenger compartment that contribute to the global vehicle rigidity. This way the global vehicle weight is minimized, this being a very favorable factor for the autonomy of the vehicle in full electric mode. The downside being that the battery replacement requires disassembly and reassembling of several containers.

The documents U.S. Pat. No. 5,392,873 and JP2007017028 disclose a synthesis of the above background. The vehicle is equipped with only one container of electric batteries fastened under the chassis with a significant number of fasteners which results in the contribution of the container structure to the global rigidity of the vehicle. However the proposed assemblies are not designed for replacements of the said container obtained by an automatic machine.

The document US2012161472 discloses an evolution of the preceding background with an important number of fastening screws, of the container of electric batteries under the chassis of the vehicle. The advantages are an important contribution of the container to the rigidity of the structure of the vehicle and a disposal of the fastening screws that allows a mechanized of the replacement of the aforementioned container.

The downside of this evolution is the difficulty to obtain the reliability required for automated replacements. Indeed, the replacements of the container require to unscrew completely and then to screw back the said fastening screws. Usually fastening screws and corresponding bolts can hardly work reliably for more than about ten complete unscrewing automated, followed by complete screwing, provided by an automatic machine, without maintenance operations. This corresponds less than ten thousand kilometers run by the vehicle. This evolution thus represents the drawback of requiring more frequent maintenance operations than usual for a vehicle.

All of the fastening devices from the anterior art cited previously require to be disassembled in two parts for the removal of the container of electric batteries, to then be assembled again to the set up of the container. Consequently, the removal and the set up of the containers require more frequent manual maintenance as usual, or the fastening mechanisms are much heavier.

The document FR2157430 discloses a fastening device that allows to removal and to reinstall a container onto a vehicle, while the fastening device stay linked to the vehicle. The drawback of said device is that it is not easily automated with an automatic machine.

The document DE102012219081 discloses a fastening mechanism including a screw and nut system cinematically linked to a lock bolt. This mechanism is a lot heavier and bulky than a traditional screw and nut system as described in aforementioned document US2012161472. This solution thus leads to a much heavier electric vehicle.

### SUMMARY OF THE INVENTION

The purpose of the invention is to propose a new evolution of the state of the art, which incorporate a light and compact device that can clamp a container to a vehicle, and release it from this vehicle, with a regular reliability, through a automated machine or through a manually operated tool.

In the previous paragraph and in the rest of this document, the term container designates a container designed to be installed onto a vehicle, this container having the function of storing energy which permits to supply said vehicle.

The said vehicle includes a chassis comprising a housing designed to position a removable container onto the vehicle and a device, object of the invention, that can clamp this container to the chassis, or release it from the Chassis. The said device comprises at least one mechanism including a clamping system which integrates a screw, a nut and a flange. The screw forms a screw head and a shank partially or totally threaded. The flange incorporates a through hole. The screw shank crosses over through the said hole and is partially screwed into the nut.

Each mechanism according to the invention can clamp together the container to the chassis, thanks to its clamping system. This clamping is obtained between the flange and the nut of the clamping system of each mechanism, the screw providing the mechanical link between said flange and the said nut. The integrality of the force of said clamping of the container to the chassis of the vehicle can transits by the said screw. For each mechanism, the clamping of the container to the chassis of the vehicle of is obtained by the screwing of the screw. The release of said clamping the container from the chassis of the vehicle is obtained by the unscrewing of said screw. In the following part of the present document, clamping system is the expression that designates a system of clamping such as described above.

A first aspect of the invention is that the clamping system of the mechanism is completed by at least one restraining piece and a kinematic link. The restraining piece ensures a translational connection between the flange and the screw in parallel to the screw and leaving the flange with at least one free movement in the plane perpendicular to the screw. The said kinematic link achieves a movement transmission of the flange in relation to the screw with a torque limiting function, such that either the screw rotation drives the flange in parallel movement to the screw and also in perpendicular movement to the screw, or the screw rotation drives the flange only in a parallel movement to the screw because the flange is immobilized from elsewhere in a perpendicularly plans to the screw.

A second aspect is that the said mechanism includes a guide whose a function, in correlation with the screw and the restraining piece, is to delimit at least one zone of movement of the flange in a perpendicular plane to the screw.

A third aspect is that the said mechanism is either linked to the vehicle due to the fact that the nut and the guide are immobilized in relation to the chassis of the vehicle or linked to the container due to the fact that the nut and the guide are immobilized in relation to the container.

A fourth aspect is that the screw head is easily accessible to be screwed or unscrewed by an automatic machine or with help of a tool manually actuated.

A fifth aspect is that the screwing of the screw drives the flange in a clamping position of the container to the vehicle and that the partial unscrewing of the screw is sufficient to release the container from the vehicle in order to its removal from the vehicle.

The present invention also relates to a vehicle including a container characterized by the fact that it includes of at least one device as described previously. This said device can be positioned under the chassis of the vehicle or under the trunk in the case of an automotive.

The characteristics and advantages of the present invention are detailed more clearly in the description which follows of several examples of embodiment in reference to the attached figures. These examples of embodiments are not limitations of the different ways to achieve the invention.

### BRIEF DESCRIPTION OF THE DRAWINGS

FIG. 1 provides a perspective view of a clamping system.

FIG. 2 provides a perspective view of a mechanism in released position.

FIG. 3 provides a perspective view of a mechanism in intermediate position.

FIG. 4 provides an exposed view of the different pieces constituting the mechanism.

FIG. 5 provides a perspective view of a restraining piece and of a kinematic link.

FIG. 6 provides a cross sectional view of a restraining piece and of a kinematic link.

FIG. 7 provides a partial cross section view of the mechanism fixed relative to the chassis of a vehicle

FIG. 8 provides a perspective view of a part of the underside of the chassis of a vehicle equipped with a mechanism in released position.

FIG. 9 provides a perspective view of a part of the underside of the chassis of a vehicle equipped with a container clamped by mechanisms.

FIG. 10 provides shows an above view of a part of the chassis of a vehicle equipped with a container clamped by at least two mechanisms.

FIG. 11 provides a cross sectional view of the chassis of a vehicle equipped with a container clamped by at least one mechanism.

FIG. 12 provides a cross sectional view according to a longitudinal and vertical plan of the chassis of a vehicle equipped with a container clamped by at least two mechanisms.

FIG. 13 provides an underneath view of a part of the chassis of a vehicle equipped with a container clamped with at least two mechanisms in intermediate position.

FIG. 14 provides a cross sectional view of a part of the chassis of a vehicle equipped with a container and with at least one mechanism in intermediate position.

FIG. 15 provides a cross sectional view according to a longitudinal and vertical plan of a part of the chassis of a vehicle equipped with a container and with at least two mechanisms in clamped position.

FIG. 16 provides an underneath view of a part of the chassis of a vehicle equipped with a container and with at least two mechanisms in clamped position.

FIG. 17 provides a cross sectional view of a part of the chassis of a vehicle equipped with a container and with at least one mechanism in released position.

FIG. 18 provides a cross sectional view according to a longitudinal and vertical plan of a part of the chassis of a vehicle equipped with a container and with at least two mechanisms in released position.

FIG. 19 provides an exposed view of the different pieces constituting the mechanism, for a second alternate assembly.

FIG. 20 provides a perspective view of a mechanism in released position, for the second alternate assembly unclamped.

FIG. 21 provides a perspective view of a mechanism in clamped position, for the second alternate assembly

FIG. 22 provides a cross sectional view of a part of the chassis of a vehicle equipped with a container clamped by at least one mechanism in clamped position, for the second alternate assembly.

FIG. 23 provides a cross sectional view of a part of the chassis of a vehicle equipped with a container with at least one mechanism in released position, for the second alternate assembly.

FIG. 24 provides an exposed view of the different pieces of a mechanism, for a third alternate assembly.

FIG. 25 provides a perspective view of a mechanism in released position, for the third alternate assembly.

FIG. 26 provides a perspective view of the mechanism in clamped position for the third alternate assembly.

FIG. 27 provides a cross sectional view of a part of the chassis of a vehicle equipped with a container clamped by at least two mechanisms in clamped position, for the third alternate assembly.

FIG. 28 provides a cross sectional view of a part of the chassis of a vehicle equipped with a container clamped in position with at least mechanism, for the third alternate assembly.

FIG. 29 provides a cross sectional view according to a longitudinal and vertical plan of the chassis of a vehicle equipped with a container clamped in position with at least two mechanisms, for the third alternate assembly.

FIG. 30 provides an underneath view of a part of the chassis of a vehicle equipped with a container and with at least two mechanisms in released position, for the third alternate assembly.

FIG. 31 provides a cross sectional view of a part of the chassis of a vehicle equipped with a container and with at least two mechanisms in released position, for the third alternate assembly.

FIG. 32 provides a cross sectional view according to a longitudinal and vertical plan of a part of the chassis of a vehicle equipped with a container and with at least two mechanisms in released position, for the third alternate assembly

FIG. 33 provides an exposed view of the different pieces of a mechanism, for a forth alternate assembly.

FIG. 34 provides a perspective view of a mechanism in released position, for the forth alternate assembly.

FIG. 35 provides a perspective view of the mechanism in clamped position for the forth alternate assembly.

FIG. 36 provides a cross sectional view of a part of the chassis of a vehicle equipped with a container clamped by at least two mechanisms in clamped position, for the forth alternate assembly.

FIG. 37 provides a cross sectional view of a part of the chassis of a vehicle equipped with a container clamped in position with at least mechanism, for the forth alternate assembly.

FIG. 38 provides a cross sectional view according to a longitudinal and vertical plan of the chassis of a vehicle equipped with a container clamped in position with at least two mechanisms, for the forth alternate assembly.

FIG. 39 provides a cross sectional view of a part of the chassis of a vehicle equipped with a container and with at least two mechanisms in released position, for the forth alternate assembly.

FIG. 40 provides a cross sectional view according to a longitudinal and vertical plan of a part of the chassis of a vehicle equipped with a container and with at least two mechanisms in released position, for the forth alternate assembly;

FIG. 41 provides a view of a mechanism with another design of the in flange.

### DESCRIPTION OF THE SPECIFIC EMBODIMENTS

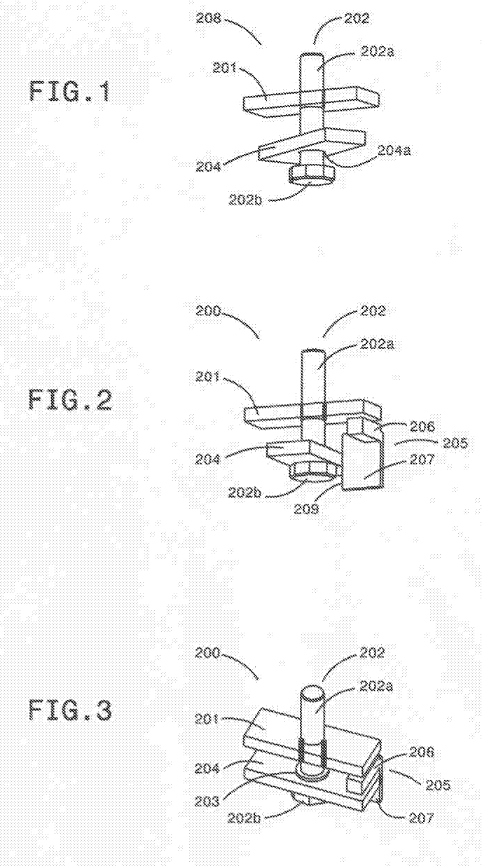

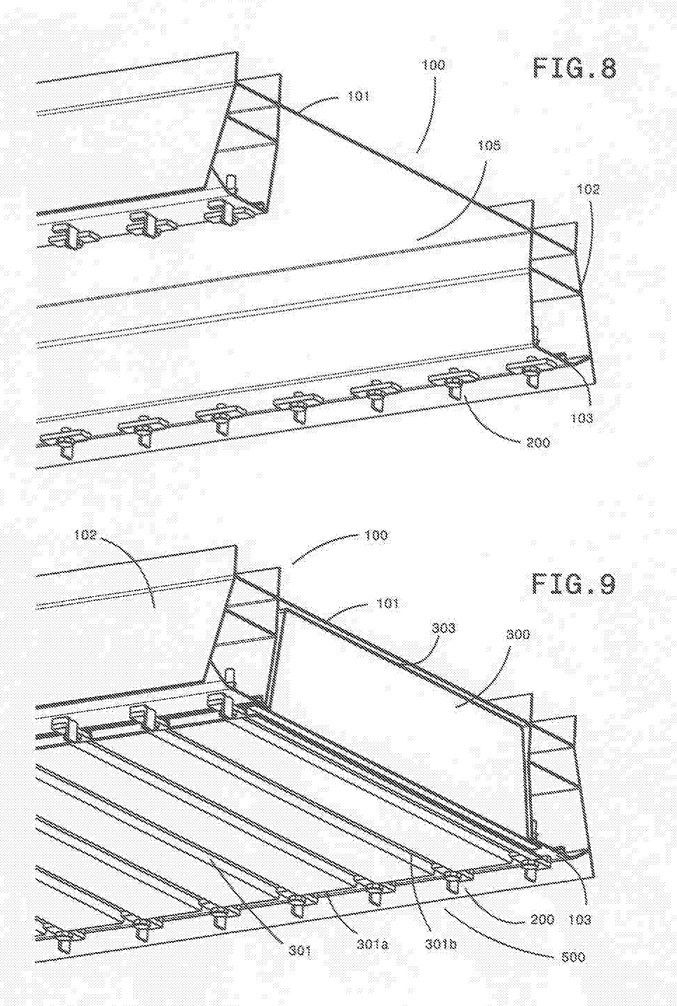

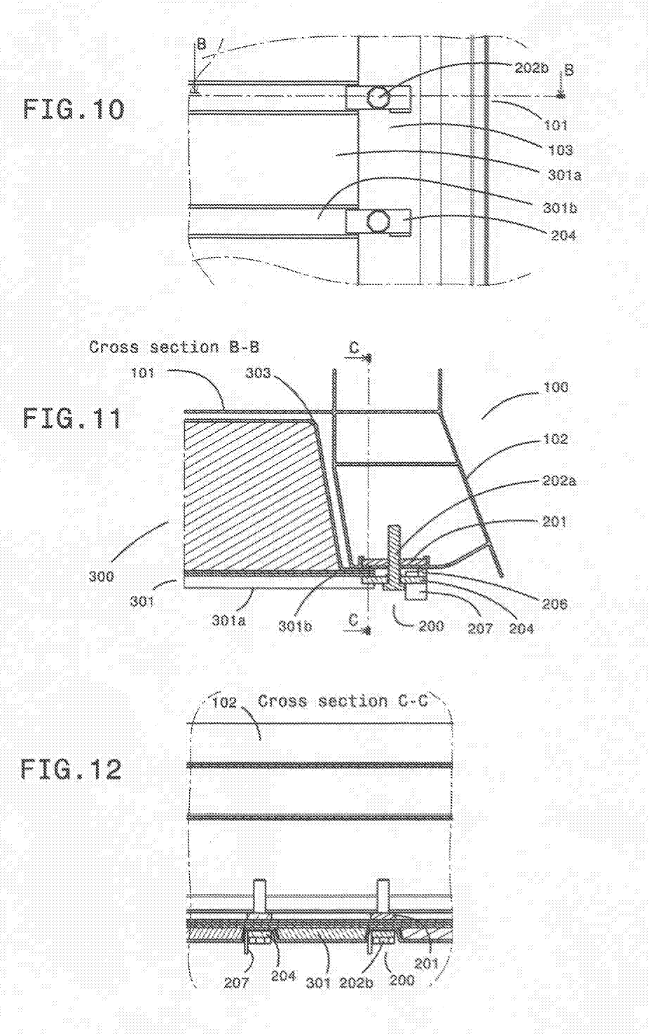

The following description refers to a first preferential embodiment for a device according to the invention. This first embodiment is provided on FIGS. 1-18. The FIGS. 1-4 are at the same scale. The FIGS. 5 and 6 are at a scale of double. The FIGS. 8 and 9 are at a scale of three eighth. The FIGS. 10-18 are at a scale of one half.

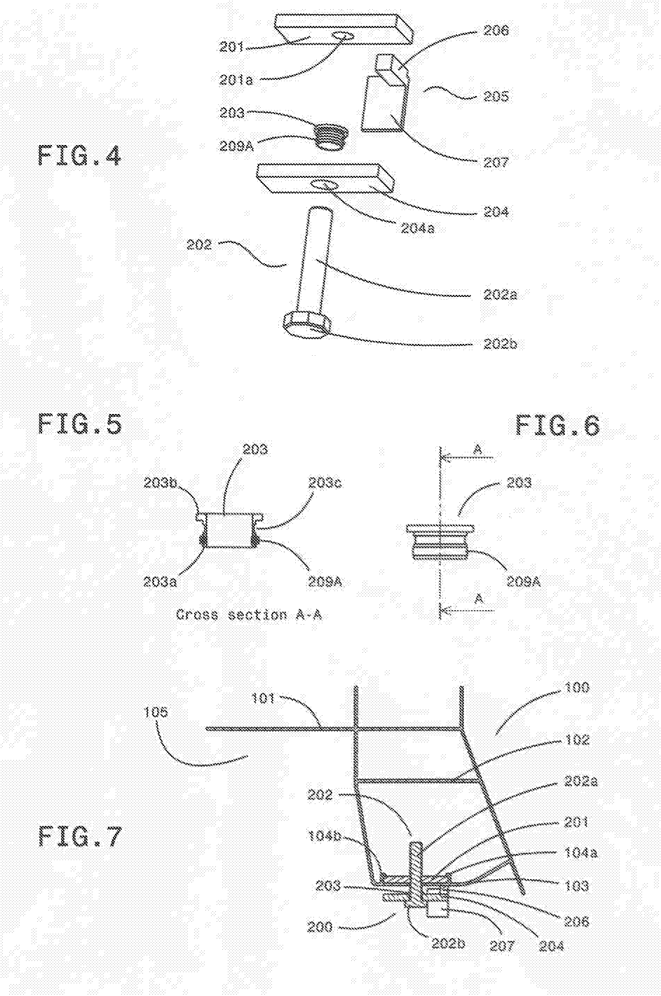

A device 500, according to the invention, referring to FIGS. 11 and 17, includes at least one mechanism 200 linked to a chassis 100 of an electric vehicle in order to allow the clamping and the release a container 300 on the said vehicle. The mechanism 200 integrates, referring to FIG. 4, a clamping system 208, a guide 205, a restraining piece 203 and a kinematic link. The Clamping system 208 is represented on FIG. 1. The clamping system 208 is an assembly between a nut 201, a screw 202 and a flange 204. The nut 201 is of a rectangle parallelepiped shape; it is drilled at the center of the base of the parallelepiped by a through and threaded cylindrical hole. The flange 204 of rectangle parallelepiped shape has dimensions approximately equal to the dimensions of the nut 201. The flange 204 is drilled at the center of its base by a through smooth hole 204a which is cylindrical. The screw 202 is constituted by a screw shank 202a partially or fully threaded and a screw head 202b.

This screw 202 screws clockwise and unscrews counter clockwise. Its screw shank 202a cross through said smooth hole 204a of the flange 204 and is partially screwed in the nut 201. The threading existing on the screw and in the nut 201 are not drawn on the figures of this document.

FIGS. 5 and 6 represents the restraining piece 203 equipped with two friction rings 209A. The restraining piece 203 is metallic; it is constituted by an annulus 203a and a shoulder 203b. The annulus 203a includes two external grooves 203c. The friction rings 209A are made in polytetrafluoroethylene (PTFE) containing twenty five percent of graphite. These two friction rings 209A are pasted with strong glue into two external grooves 203c. Only one friction ring 209A is represented on FIG. 6.

The mechanism 200 is represented on FIGS. 2 and 3 according to the invention. The annulus 203a is assembled hooped onto the screw shank 202a and sliding in the smooth hole 204a of the flange 204, in such a manner that the flange 204 is restrained close to the nut 201, while keeping a functional clearance between the screw head 202b and the shoulder 203b. This assembly ensures an axial translational connection between the flange 204 and the screw 202 and leaves the flange 204 in free rotation around the screw 202. This rotation is a movement in the plane perpendicular to the screw 202. The two friction rings 209A are compressed between the smooth hole 204a and the annulus 203a. This assembly forms a kinematic link between the flange 204 and the screw 202. The friction rings 209A and the annulus 203a cooperate to assure a rotation connection between the flange 204 and the screw 202 comprising a limitation due to the limit of adherence between the friction rings 209A and the smooth hole 204a. Consequently due to the above mentioned characteristics, if the screw 202 is driven in rotation and the flange 204 is not stopped by an obstacle or is not braked by an important friction, then the flange 204 rotates with the screw 202. If the screw 202 is driven in rotation and the flange 204 is stopped by an obstacle or is braked by an important friction, then the flange 204 does not rotate and the friction rings 209A slip in rotation into the smooth hole 204a. Thus, the said kinematic link between the screw 202 and the flange 204 includes a torque limitation function.

The guide 205 forms a base 206 and a stop with a small front 209 which is parallel to the screw and perpendicular to the biggest length of the nut 201, as well as a large front 207 which is perpendicular to the small front 209 and parallel to the screw. The mechanism 200 is represented in released position in FIG. 2. The flange 204 is perpendicular to the nut 201 and in support on a small front 209. The mechanism 200 is represented on FIG. 3 with the flange 204 which is parallel to nut 201 and in support on the large front 207.

FIG. 7 represents a partial view of a passenger floor 101 and of a longitudinal frame 102, of a chassis 100 from a vehicle equipped with a device 500 including at least one mechanism 200. The mechanism 200 is represented in clamping position on FIG. 7, without the container 300. Said cross sectional view goes through the screw axis of the mechanism 200. The longitudinal frame 102 is placed laterally to the vehicle, under its passenger compartment. Another longitudinal profile (not shown on the figures) is set in symmetrical position compared to the vehicle longitudinal axis. These two longitudinal frames 102 and the passenger floor 101 delimit a housing 105 to set up a container. The longitudinal frame 102 has a wall 103 accessible from underside of the vehicle.

The wall 103 includes two guide ways 104a and 104b located inside the longitudinal frame 102. The wall 103 is pierced by a through hole under said vehicle. The screw shank 202a goes through this hole. The nut 201 is immobilized to the chassis 100 in the lateral and vertical directions thanks to two guide ways 104a and 104b of the wall 103. The nut 201 is equally immobilized in the longitudinal direction with the chassis 100 thanks to cooperation of said hole pierced in the wall 103 and the screw 202 which is screwed in the nut 201. So, the mechanism 200 is linked to the vehicle and the nut 201 is completely immobilized onto the chassis 100 of the vehicle.

The guide 205 of device 500 is welded onto the wall 103 such as:
The rear of flange 204 in clamping position is in support onto the vertical plane of the base 206 and in stop onto the large front 207, as shown FIGS. 7 and 11.
The rear of the flange 204 of the mechanism 200 in released position is stopped onto the small front 209, as shown on FIGS. 2, 8 and 17.

FIG. 8 shows a perspective partial view of the same part of the chassis 100 of the vehicle as seen on FIG. 9, equipped with the device 500 but with the container 300 removed. The mechanism 200 of the device 500 is in released position.

FIG. 9 shows a perspective partial view of a part of the chassis 100 of the vehicle equipped with a container 300 and with the device 500. The container 300 is set up in the housing 105 formed in the chassis 100. The mechanisms 200 of the device 500 are in clamped position.

In reference to FIGS. 9, 10, 11 and 12, the mechanisms 200 clamp the container 300 onto chassis 100. The container 300 is stiffened thanks to grooved floor 301 and a shell 303. The grooved floor 301 has several raised portions 301a and several bottoms 301b.

When the mechanism 200 is in clamping position, the clamping system 208 clamps together the wall 103 of the chassis 100 with a wall of the container 300, between the nut 201 and the forward part of the flange 204; said wall of the container 300 is in this case the bottom 301b of the grooved floor 301. Besides, the clamping system 208 clamps together the wall 103 of chassis 100 and the base 206 of the guide 205, between the nut 201 and the rear part of the flange 204.

The wall 103 is clamped on a large surface of the mechanism 200, thus strengthening the wall 103 of the vehicle equipped with a container 300 clamped to chassis 100, according to the invention. This reinforcement induces that the wall 103 doesn't have to be strengthened with an additional piece, this is an advantage for minimize the global weight of the vehicle.

Additionally, the clamping system 208 is designed following simple and robust construction principles. Given these characteristics, the mechanisms 200 are light and compact, which allows to clamp the container 300 onto the chassis 100 with a large number of fixation points. The advantage is a good turnout from the rigidity of the container 300 to rigidity of the chassis 100. This is an additional advantage that can for minimize the global weight of the vehicle.

The screw heads 202b are accessible vertically from beneath the vehicle. The advantage is that the screws are easily accessible for operations of screwing and unscrewing with an automatic machine or with the help of a tool manually driven.

FIGS. 10, 11 and 12 show a part of the chassis 100 equipped with device 500 and a part of the container 300. The clamping systems 208 clamp the container 300 onto the chassis 100. The flanges 204 are in clamping position. They are parallel to the nut 201 in support onto the bottoms 301b and onto the base 206. The flange 204 is in support onto the large front 207.

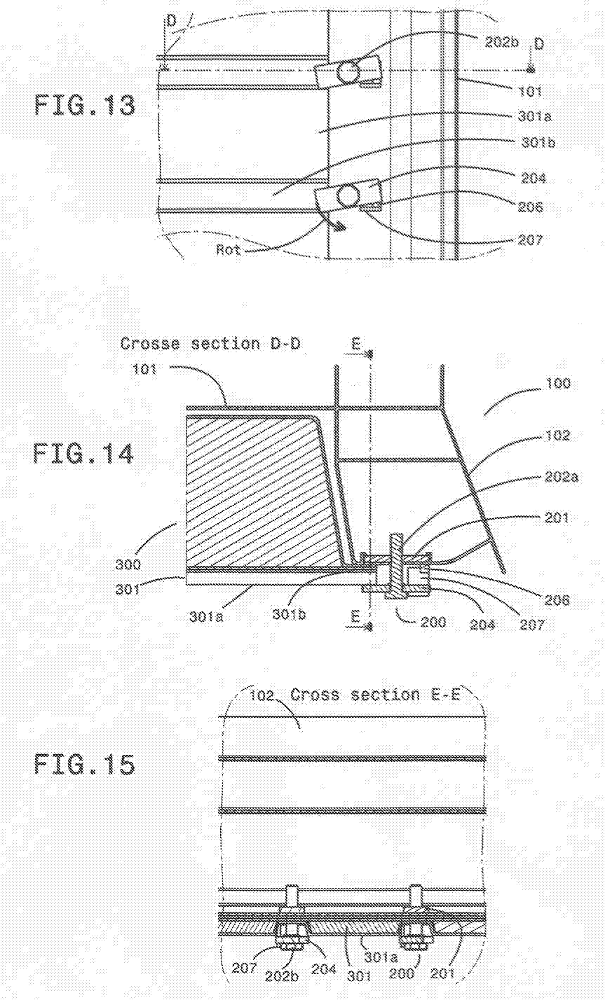

FIGS. 13, 14 and 15 show a part of the chassis 100 equipped with the device 500 and a part of the container 300. The mechanisms 200 are in intermediate position. The container 300 is vertically supported by a mean not represented. The screw head 202b is driven counter clockwise Rot, thanks to a tool not represented. The flange 204 is placed at the limit to pass above the raised portions 301a. The passage from clamping position to this intermediate position is obtained by the driving in unscrewing of the screw 202 and comprises three phases. During the first phase, the flange 204 begins to move away from the bottoms 301b without turning, while the friction rings 209A slides into the smooth hole 204a.

During the second phase, the flange 204 continues to move away from the bottoms 301b and rotates with the screw until it reaches the wall linking the bottoms 301b to the raised portions 301a. In the third phase, the flange 204 moves away from the bottoms 301b while rubbing on the wall linking the bottoms 301b to the raised portions 301a; the flange 204 doesn't rotate compared to the screw 202 while there is a slip between the friction rings 209A and the smooth hole 204a.

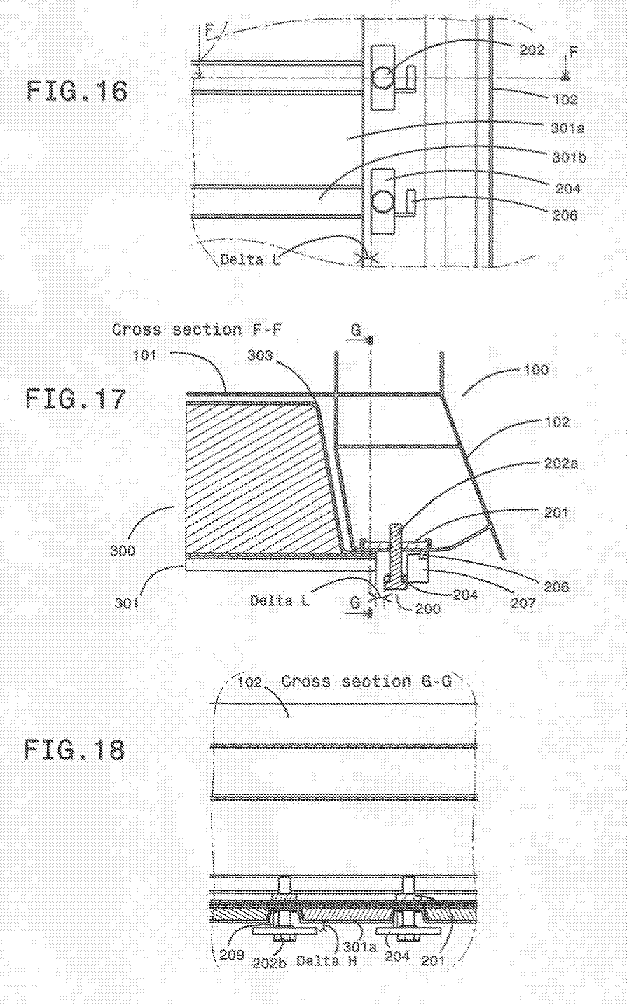

FIGS. 16,17 and 18 show a part of the chassis 100 equipped with the device 500 and a part of the container 300. The mechanisms 200 are in released position. The container 300 is supported held in vertical direction with a device not represented. The flange 204 is perpendicular to the nut 201 in support on the small front 209. The flange 204 is spaced laterally from the container 300 with a horizontal interval Delta L. In this configuration, the container 300 can be removed from the vehicle without mechanical interference, by going down in vertical direction, or set up again onto the vehicle without mechanical interference, by vertical lifting.

The flanges 204 are located at a vertical spacing Delta H in vertical plane underneath of the raised portions 301a. The passage from intermediate position is obtained by the driving of the screw 202 in unscrewing and includes two phases. During the first phase, the flange 204 moves away from the bottoms 301b and rotates with the screw 202 until reaching in stop position onto the small front 209. During the second phase, the flange 204 moves away from the bottoms 301b, rubbing onto the small front 209, the flange 204 doesn't rotate relative to the screw 202 while there is a slip between the friction rings 209A and the smooth hole 204a.

The passage from released position represented on FIGS. 16, 17 and 18 to the clamping position represented on FIGS. 10, 11 and 12 is obtained by driving the screw 202 in screwing and includes four phases.

During the first phase, the flange 204 gets closer to the bottom 301b and rotates with the screw until it abuts on the large front 207. During the second phase, the flange 204 keeps getting closer to the bottoms 301b, rubbing on the large front 207 while there is a slip between the friction rings 209A and the smooth hole 204a. During the third phase, the flange 204 is in support against the bottom 301b and the pressure between these two pieces increases until the screw 202 reaches nominal tightening torque, the flange 204 doesn't rotate relative to the screw 202, while there is a slip between the friction rings 209A and the smooth hole 204a.

The rotation of the screw 202 causes a displacement of the flange 204 parallelly to the screw and also, the rotation of the screw 202 causes a torque tending to move the flange 204 in a plane perpendicular to the screw 202, so that the screwing of the screw 202 has the effect of clamping the container 300 on the chassis 100 and the partial unscrewing of the screw 202 has the effect of releasing the container 300 creating a free horizontal interval Delta L between the container 300 and the flange 204 which allows passage of the container 300 from the housing 105 to outside the vehicle and vice versa.

The invention thus allows removal and reinstallation of the container 300 on the vehicle while the screws 202 of the mechanisms 200 remain always engaged in their respective nuts 201. The fact of to partially unscrew the screws 202 is therefore sufficient to release the container 300 and enable its removal from the vehicle. This functionality of the invention is a pledge of reliability. Moreover, to further increase the reliability, the threads of the screws 202 and nuts 201 are lubricated with graphite grease, not shown.

Moreover, some electrical connections allow to link the container 300 to the vehicle according to techniques of the prior art, in order to allow to plug and unplug said electrical connections between the container 300 and the vehicle, automatically to respectively during the removal and refitting of the container 300. These electrical connections are not the object of the present invention and are not represented. Some guiding devices non-represented allow centering of the container 300 to its introduction into the housing 105. Such guiding devices are part of the state of the art.

For a vehicle whose the container 300 is accessible from the underside of the vehicle and whose the container 300 withdraws vertically down and the gets back into place in the housing 105 by lifting it vertically, the replacement of a container 300 requires the achieving the following operations
Support the weight of the container 300;
Partially unscrew the screws 202 until getting the horizontal interval Delta L or Delta LB, to allow the moving down and then up of the container 300;
Move down vertically the container 300;
Center the replacement container 300 under the housing 105;
Move vertically up the replacement container 300 and insert it into the housing 105;
Tighten again the screws 202 to a nominal torque.

The mechanisms 200 are able of achieving between two interventions of manual maintenance, a high number of operations of clamping and of releasing of the container 300, being operated either manually using a tool or automatically thanks to an automatic machine, because of following advantages of the invention:
1) the various parts of the mechanism 200 are able to be constructed for high robustness;
2) the threads of the screws 202 and their respective nuts 201 remain engaged during the exchanges of the container 300, furthermore they are greased with a tenacious and powerful grease;
3) the material of the friction rings 209a of the kinematic link has a very high wear resistance.

Thanks to the characteristics described above, automatic machines of the art state are able to perform reliably the operations described in the preceding paragraph to replace a container 300 on the vehicle.

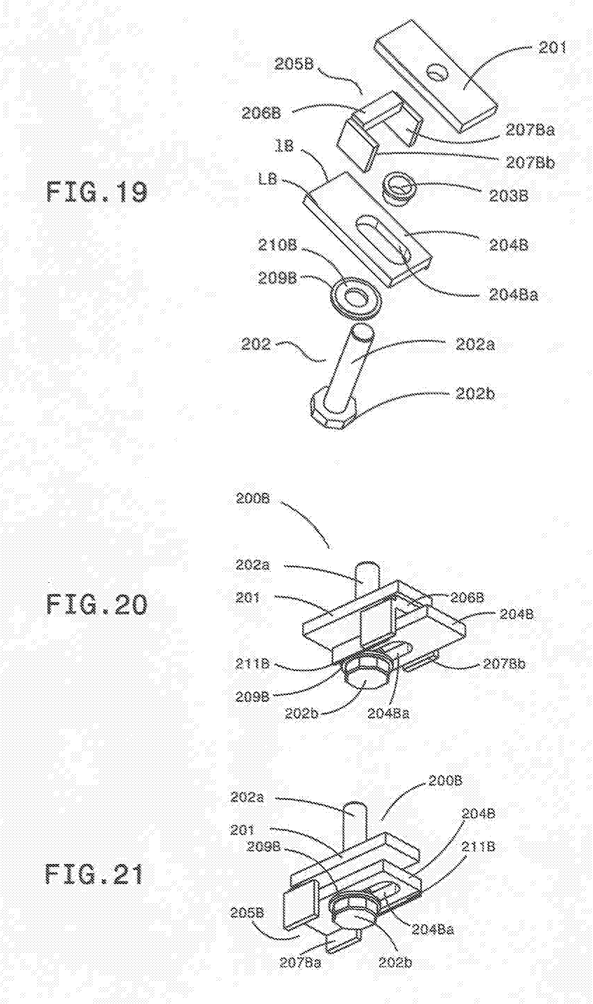

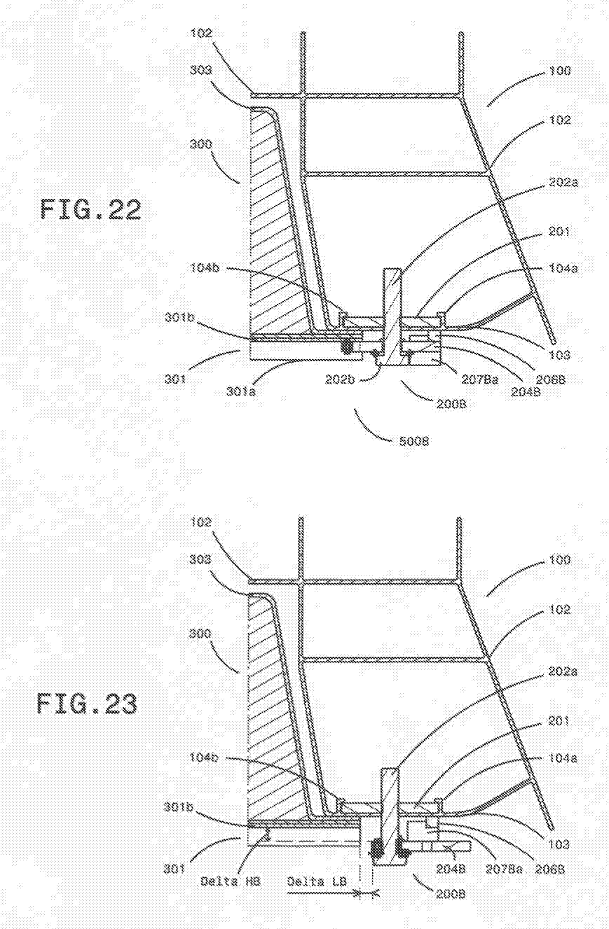

The part of the following description will focus on a second preferred embodiment of a device according to the invention. This second embodiment is shown in FIGS. 19 to 21. The drawings of FIGS. 19 to 21 are to the same scale as FIGS. 1 to 4. The drawings of FIGS. 22 and 23 wide by three-quarters.

Referring to FIGS. 19 and 22 a device 500B according to this second embodiment has at least one guide 205B and at least one mechanism 200B which is the assembly of a restraining piece 203B, a kinematic connection and a clamping system which consists of a nut 201, a screw 202 and a flange 204B.

The mechanism 200B differs from a mechanism 200 by a flange 204B, a kinematic link B, a restraining piece 203B, a guide 205B and displacements of the flange 204B which differ from the first mode. These parts are shown in FIG. 19. All other features of the first preferred embodiment are retained for this second preferred embodiment.

The flange 204B has the general shape of a rectangular parallelepiped whose base has the width 1B and length LB. The flange 204B has a drive track 211B. It is pierced by a hops hole 204Ba. This drive track 211B is placed parallel to the length LB, in lateral position above the base of the rectangular parallelepiped. The hops hole 204Ba is smooth and crossing through. It is parallel to the drive track 211B and opens on both sides in the middle of the base of the rectangular parallelepiped.

The kinematic connection B comprises a metal rim 210B and a friction ring 209B made of polytetrafluoroethylene graphitized to twenty-five percent. The rim 210B has a reamed hub. The friction ring 209B is mounted in the rim 210B and stuck with strong glue. Said reamed hub of the rim 210B is hooped onto the screw shank 202a of the screw 202, so that the rim 210B is in contact with the screw head 202b.

The restraining piece 203B is metallic; it forms a ring and an outer shoulder. This ring is mounted shrunk onto the screw shank 202a and slippery in hops hole 204Ba, so that the flange 204B is held very close to the rim 210B, by providing a clearance between the rim 210B and the shoulder of the restraining piece 203B. The flange 204B is movable radially relative to the screw 202, guided by the cooperation of its hops hole 204Ba and the screw shank 202a.

As shown in FIGS. 20 and 21, the mounting is performed so that, for any displacement of the flange 204B, the screw shank 202a remains equidistant from the drive track 211B and the friction ring 209B remains in contact with the drive track 211B. The kinematic connection B is achieved by the compression of the friction ring 209B between the drive track 211B and the rim 210B.

Referring to FIG. 19, the guide 205B forms a base 206B and two legs. Each leg comprises a large front 207Ba, 207Bb parallel to the screw and perpendicular to the greatest length of the nut 201. The two large fronts 207Ba, 207Bb face. The mechanism 200B is showed in clamping position in FIG. 22 and in released position in FIG. 23. The guide 205B is welded to the wall 103 so that:
The back of the flange 204B in clamping position is in support in the vertical plane on the base 206B;
For all the possible translations of the flange 204B with respect to the nut 201, the flange 204B remains parallel to the nut 201, due to the guiding achieved by the cooperation of the screw 202 and the large fronts 207Ba and 207Bb.

The friction ring 209B in cooperation with the rim 210B and the drive track 211B connects in translation the flange 204B to the rotation of the screw 202, with a limitation due to the adhesion between the friction ring 209B and the drive track 211B. Because of the above characteristics and of the ability to friction of the material constituting the friction ring 209B, if the screw 202 is rotated and the flange 204B is not stopped by an obstacle or braked by high friction, then the friction ring 209B which rotates with the screw drives the flange 204B in translation by adherence, in a plane perpendicular to the screw 202. If the screw 202 is rotated and the flange 204B is stopped by an obstacle or braked by high friction, then the flange 204B is not translated in a plane perpendicular to the screw 202 and the friction rings 209B slip on the drive track 211B. The kinematic connection B between the screw 202 and the flange 204B therefore incorporates a torque limiter function.

In FIG. 20, the flange 204B is retracted relative to the nut 201 in limit of displacement due to the contact between one end of hops hole 204Ba and the screw shank 202a. In this position, if the screw 202 is driven by unscrewing, then the flange 204B cannot retreat with respect to the nut 201. If the screw 202 is driven in screwing, then the flange 204B moves forward until coming above of the nut 201.

In FIG. 21, the flange 204B is placed over the nut 201. In this position, if the screw 202 is driven by unscrewing, then the flange 204B moves in a plane perpendicular to the screw 202. If the screw 202 is driven in screwing, then the flange 204B does not move in a plane perpendicular to the screw 202.

FIG. 22 shows part of the chassis 100 equipped with the device 500B and a portion of the container 300. The clamping systems clamp the container 300 on the chassis 100. The flanges 204B are in clamping position. They are parallel to the nuts 201 in support on the bottoms 301b and on the base 206B.

FIG. 23 shows part of the chassis 100 equipped with the device 500B and a portion of the container 300. The mechanisms 200B are in released position. The container 300 is supported vertically by a not shown device. The flange 204B is retracted relative to the nut 201. The flange 204B is laterally spaced from the container 300 of a horizontal interval Delta LB. In this configuration, the container 300 may be removed from the vehicle without mechanical interference, being descended vertically, or replaced on the vehicle without mechanical interference, being raised vertically. The flange 204B is located at a vertical spacing Delta HB in the vertical plane, below the bottoms 301b.

The rotation of the screw 202 causes a displacement of the flange 204B parallel to the screw and also, the rotation of the screw 202 induces a force which tends to move the flange 204B in a plane perpendicular to the screw 202, so that the screwing of the screw 202 has the effect of clamping the container 300 on the chassis 100 and the partial unscrewing of the screw 202 has the effect of releasing the container 300 creating a free horizontal interval Delta LB between the container 300 and the flange 204B that allows passage of the container 300 from the housing 105 to outside the vehicle and vice versa.

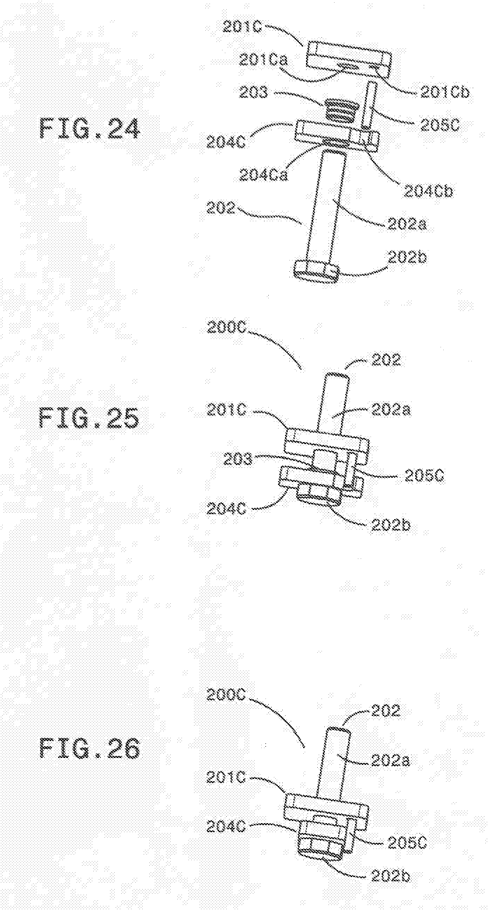

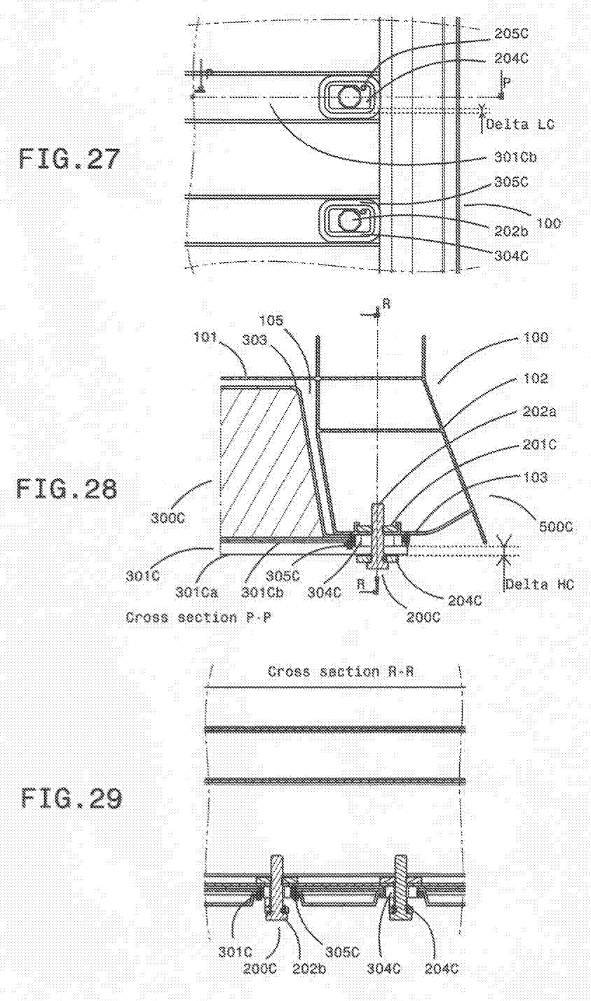

Part of the description which follows relates to a third preferred embodiment of a device according to the invention. This third embodiment is shown in FIGS. 24 to 32. The drawings of FIGS. 24 to 26 are to the same scale as FIGS. 1 to 4. The drawings of FIGS. 27 to 32 are at the scale of one half.

Referring to FIGS. 24, 28 and 31, a device 500C according to this third embodiment comprises at least one mechanism 200C which is the assembly of a nut 201C, a screw 202, a restraining piece 203, a flange 204C and a guide 205C. The nut 201C comprises a fixing hole 201Cb of the guide 205C and flange 204C comprises a recess 204Cb which allows delimiting in one direction the drive in rotation of the nut 201C relative to the flange 204C.

Referring to FIGS. 24, 28 and 31, a device 500C according to this third embodiment comprises at least one mechanism 200C which is the assembly of a nut 201C, a screw 202, a restraining piece 203, a flange 204C and a guide 205C. The nut 201C comprises a fixing hole 201Cb of the guide 205C and flange 204C comprises a recess 204Cb which allows to delimit in one direction of rotation the drive of the nut 201C relative to the flange 204C. The nut 201C is pierced by the threaded hole 201Ca and the flange 204C is pierced by the smooth hole 204Ca. Displacements and drive modes of the flange 204C relative to the nut 201C are identical to those of the mechanism 200 according to the first embodiment. FIG. 25 shows the mechanism 200C in the release position and the FIG. 26 shows the mechanism 200C in clamping position.

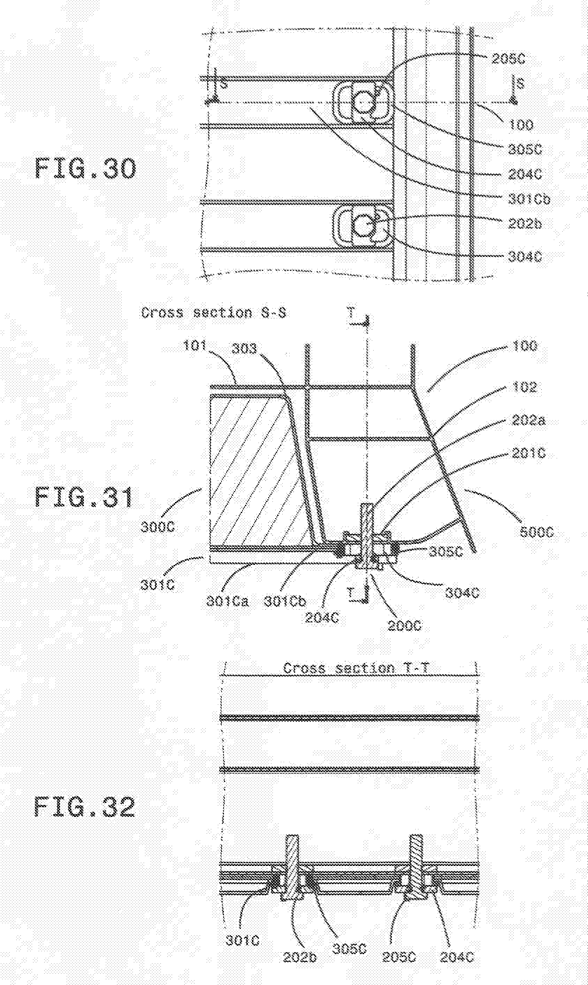

FIGS. 30-32 show a device 500C in clamping position of a container 300C on the vehicle. The container 300C has a grooved floor 301C including bottoms 301Cb and raised portions 301Ca. The bottoms 301Cb are drilled buttonholes 304C. The buttonholes 304C are reinforced by reinforcing insert 305C. In clamping position, the clamping together of the wall 103 of the chassis 100 with the wall of the container 300C comprising the reinforcing insert 305C is achieved between the front and the rear of the flange 204C and of the nut 201C which enclose two opposite edges of the reinforcing insert 305C. The clamping force passes entirely by the screw 202 as for all embodiments of the invention.

FIGS. 27-29 show a device 500C in released position of the container 300C in place in the housing 105 of the vehicle. The interior of the reinforcing insert 305C in the buttonhole 304C is larger than the large face of the flange 204C, that creates in the horizontal plane a horizontal interval Delta LC between the inside of the reinforcing insert 305C and the outside of the flange 204C.

The container 300C can be removed and installed again vertically from and onto the vehicle. In the vertical plane, a vertical spacing Delta HC between the reinforcing insert 305C and the flange 204C allows the latter to rotate without interfering with the container 300C. The rotation of the screw 202 therefore allows the clamping or the release of the container 300C relative to the vehicle.

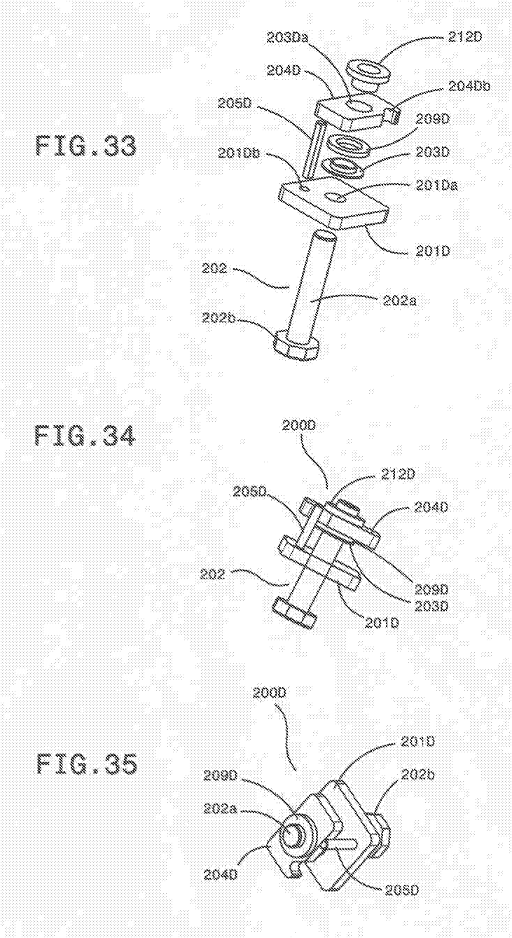

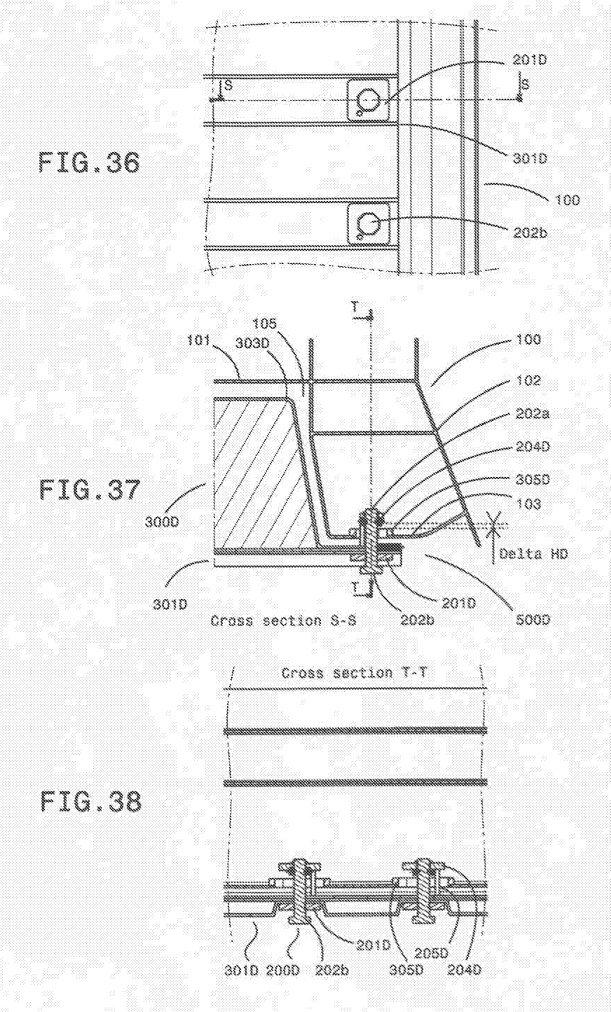

Part of the description which follows relates to another embodiment of a device according to the invention. This embodiment is shown in FIGS. 33 to 40. The drawings of FIGS. 33 to 35 are to the same scale as FIGS. 1 to 4. The drawings of FIGS. 36 to 40 are at the scale of one half.

Referring to FIGS. 33 to 40, according to this another embodiment a device 500D comprises a container 300D and at least one mechanism 200D which is the assembly of a nut 201D, a screw 202, a restraining piece 203D, a flange 204D, a guide 205D, a stopping piece 212D and a friction ring 209D. The nut 201D comprises a fixing hole 201Db for a guide 205D and a threaded hole 201Da for the screw 202. The flange 204D comprises a recess 204Db and a smooth hole 203Da. The cooperation of the flange 204D and the guide 205D delimit a range in rotation of the flange 204D relative to the nut 201D. The restraining piece 203D and the stopping piece 212D compress together the friction ring 209D and the flange 204D. The advantage of this design is to be compatible with a flange less width. The nut 204D is nearer of the screw head 202b than the flange 204D.

Referring to FIGS. 33 to 40, according to this fourth embodiment a device 500D comprises a container 300D and at least one mechanism 200D which is the assembly of a nut 201D, a screw 202, a restraining piece 203D, a flange 204D, a guide 205D, a stopping piece 212D and a friction ring 209D. The nut 201D comprises a fixing hole 201Db for a guide 205D and a threaded hole 201Da for the screw 202. The flange 204D comprises a recess 204Db and a smooth hole 203Da. The cooperation of the flange 204D and the guide 205D delimit a range in rotation of the flange 204D relative to the nut 201D. The restraining piece 203D and the stopping piece 212D compress together the friction ring 209D and the flange 204D. This restraining piece 203D and the restraining piece 212D are fixed on the shank 202a of the screw 202 by adhesive bonding. The restraining piece 203D and the stopping piece 212D ensure a translational connection between the flange 204D and the screw 202 in parallel to the screw 202 and the cooperation with the friction ring 209D ensure a kinematic link in rotation between the screw 202 and the flange 204D, comprising a torque limiting function. The advantage of this design is to be compatible with a narrower flange. The nut 204D is nearer of the screw head 202b than the flange 204D.

The mechanism 200D is linked to the container 300D. The nut 201D and the guide 205D are immobilized in relation to the container 300D. The container 300D has a grooved floor 301D.

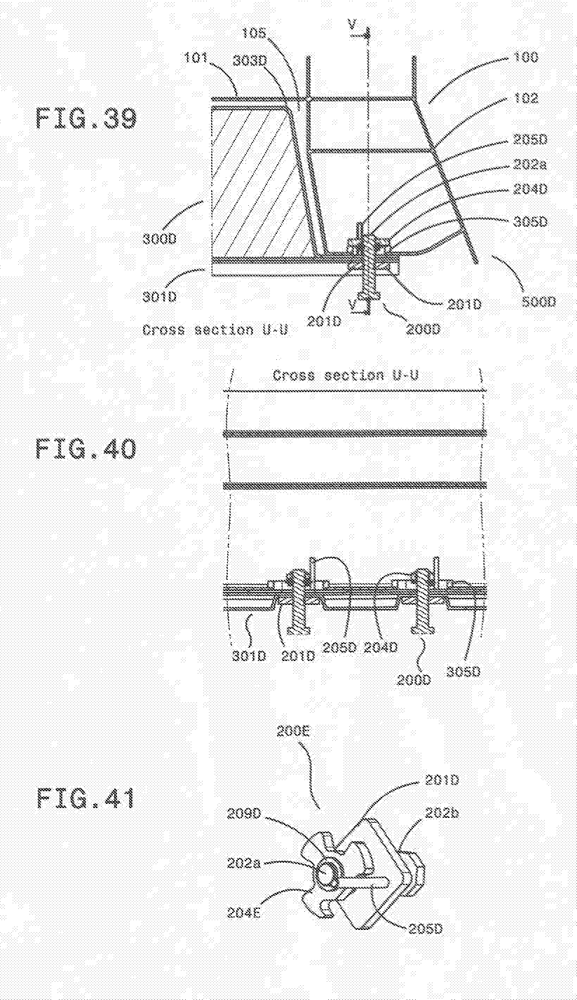

The wall 103 of the chassis 100 is open by buttonholes reinforced by reinforcing insert 305D. During the set up of the container 300D to the vehicle, le flange 204D cross through the reinforcing insert and go up until achieve a vertical spacing Delta HD, as shown in FIGS. 37 and 38. Then the driving of the screw 202 in screwing drives the rotation of the flange 204D in clamping position, as shown in FIGS. 39 and 40.

According to the invention, the flange of the mechanism can have every shape that permits to clamp and to release thank to its rotation, for example the shape shown on FIG. 41. A mechanism 200E has a flange 204E shaped triede.

The invention is applicable for clamping and releasing on a vehicle having a housing 105 for any container designed to be implanted on said vehicle, this container having the function of storing energy which can power said vehicle.

This container can contain, for example, electric power batteries or a volume of fuel. It may also contain in addition a device for generating electricity from a fuel such as a fuel cell or generator. An electrical engine vehicle equipped with electrical connectors compatible with the electrical connections of an electric battery container, of a fuel cell container and of a container incorporating a generator, the housing 105 of said vehicle being compatible with these containers, it is possible to replace on the vehicle a container of a type by another type, for example an electric batteries container by a fuel cell container or by a generator. A vehicle with full electric engine or hybrid designed to receive a container 300, 300C of electric batteries and equipped with compatible electric connectors and with a compatible housing 105, both with at least one electric battery container, at least a container incorporating a fuel cell and at least a container incorporating a generator, can integrate either a electric battery container or container incorporating a fuel cell or a container incorporating a generator.

1) A device (500), (500B), (500C), (500D) that can clamp a container (300), (300C), (300D) to, or release it from, the chassis (100) of a vehicle, where the chassis (100) comprises a housing (105) in order to position the removable container (300), (300C), (300D) on the said vehicle, said device (500), (500B), (500C), (500D) consists of at least one mechanism (200), (200B), (200C), (200D) including a clamping system (208) which is an assembly between a nut (201), (201C), (201D), a screw (202) and a flange (204), (204B), (204C), (204D), (204E), wherein:
the mechanism (200), (200B), (200C), (200D) is linked either to the chassis (100) or to the container (300), (300C), (300D);
the clamping system (208) can clamp together between its nut (201), (201C), (201D) and its flange (204), (204B), (204C), (204D), (204E), its screw (202) ensured a mechanical link between said nut (201), (201C), (201D) and said flange (204), (204B), (204C), (204D), (204E);
a restraining piece (203), (203B), (203D) ensures a translational connection between the flange (204), (204B), (204C), (204D), (204E) and the screw (202) in parallel to the screw (202) and leaving the flange (204), (204B), (204C), (204D), (204E) with at least one free movement in the plane perpendicular to the screw (202);
a kinematic link between the screw (202) and the flange (204), (204B), (204C), (204D), (204E) comprising a torque limiting function;
a guide (205), (205B), (205C), (205D) delimiting at least one zone of movement of the flange (204), (204B), (204C), (204D), (204E) in the plane perpendicular to the screw (202);
the unscrewing of the screw (202) from the nut (201), (201C), (201D) drives the flange (204), (204B), (204C), (204D), (204E) until the mechanism (200), (200B), (200C), (204D) reaches a release position, which allows the container (300), (300C), (300D) to be released from the chassis (100);
the said release position of the mechanism (200), (200B), (200C), (200D) can be achieved where the screw (202) has only been partially unscrewed;
the screwing of the screw (202) into the nut (201), (201C), (201D) drives the flange (204), (204B), (204C), (204D), (204E) until the mechanism (200), (200B), (200C), (200D) reaches a clamping position wherein the clamping system (208) clamps together between its nut (201), (201C), (201D) and its flange (204), (204B), (204C), (204D), (204E) so that the container (300), (300C), (300D) is clamped to the chassis (100);

2) The device (500), (500B), (500C), (500D) according to claim 1 or 2, wherein the mechanism (200), (200B), (200C), (200D) is connected to the container (300), (300C), (300D) linked to the chassis (100);

3) The device (500), (500B), (500C), (500D), according to claim 1 or 2, wherein the nut (201), (201C), (201D) and the guide (205), (205B), (205C), (205D) are fixed relative to the chassis (100).

4) The device (500), (500B), (500C), (500D) according to claim 1 or 2, wherein the mechanism (200), (200B), (200C), (200D) is linked to the container (300), (300C), (300D);

5) The device (500), (500B), (500C), (500D), according to claim 1 or 2, wherein the nut (201), (201C), (201D) and the guide (205), (205B), (205C), (205D) are fixed relative to container (300), (300C), (300D);

6) The device (500), (500B), (500C), (500D) according to any of the claims from 1 to 6 wherein the clamping force of the clamping system (208) required to clamp together the container (300), (300C), (300D) to the chassis (100) passes entirely through the screw (202);

7) The device (500), (500C), (500D) according to any of the claims from 1 to 7, wherein the said free movement of the flange (204), (204C), (204D), (204E), in the plane perpendicular to the screw (202), is a rotation of the flange (204), (204C), (204D), (204E);

8) The device (500B), according to any of the claims from 1 to 7, wherein the said free movement of the flange (204B) in the plane perpendicular to the screw (202) is a translational movement of the flange (204B).

9) The process for replacing a container (300), (300C), (300D) on a vehicle incorporating a housing (105) and a device (500), (500B), (500C), (500D) comprising of several mechanisms (200), (200B), (200C), (200D), according to any of the claim 4 or 6, wherein the container (300), (300C), (300D) can be removed from the housing (105) by lowering it vertically underneath the vehicle and returning it to the housing (105) by raising it vertically, the screw (202) being accessible for screwing and unscrewing, is characterized by the execution of the following operations:
supporting the mass of the container (300), (300C), (300D);
partial unscrewing of the screw (202) in order to obtain the horizontal interval (Delta L), (Delta LB), (Delta LC) allowing the container (300), (300C) to be lowered and then raised;
vertical lowering of the container (300), (300C), (300D);
approximate centering of the replacement container (300), (300C), (300D) under the housing (105);
vertical raising of the replacement container (300), (300C), (300D) and insertion into its housing (105);
Screwing in of the screws (202) until the container (300), (300C), (300D) is clamped to the chassis (100).

10) Electrically powered vehicle or a hybrid powered vehicle incorporating a device (500), (500B), (500C), (500D) according to any of the claims from 1 to 9.

11) Vehicle, according to claim 10, wherein the vehicle can incorporate, as selected, at least one container of electrical batteries or one container containing a fuel cell or one container containing a generator.

12) The device (500), (500B), (500C), (500D) according to claim 1, a wall (103) of the chassis (100) which is a part of the chassis (100) and a wall of the container (300), (300C), (300D) which is a part of the container (300), (300C), (300D), wherein the clamping system (208) clamps together said wall (103) of the chassis (100) with said wall of the container (300), (300C), (300D), between the nut (201), (201C), (201D) and a part of the flange (204), (204B), (204C), (204D), (204E) of the clamping system (208).
